(19) United States
(12) Patent Application Publication
(10) Pub. No.: US 2010/0175555 A1
(43) Pub. Date: Jul. 15, 2010

(54) Polyamide Fine Fibers

(76) Inventors: Ismael Ferrer, Minneapolis, MN (US); Castro S. Laicer, Minneapolis, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/558,499

(22) Filed: Sep. 12, 2009

Related U.S. Application Data
(60) Provisional application No. 61/096,513, filed on Sep. 12, 2008.

(51) Int. Cl. B32B 27/34; B01D 39/16; B01D 46/54

(52) U.S. Cl. 95/273; 428/401; 55/524

(57) ABSTRACT

One aspect of an improved microfiber and nanofiber properties can be obtained from a novel nylon material. The nylon can comprise a nylon copolymer comprising (diamino-dicyclohexyl)-alkane, preferably bis-(4 amino-cyclohexyl)methane and at least one other nylon monomer. Another aspect of the novel nylon can comprise a poly alkylene oxide-nylon block copolymer. Such a copolymer can contain block copolymer units wherein the block units comprise segments of ethylene oxide, propylene oxide or mixtures thereof and a nylon block comprising nylon monomers typically comprise a cyclic lactam, an alpha omega diamine and alpha omega diacid or mixtures thereof.

### CROSS REFERENCE TO RELATED APPLICATION

This application claims priority from U.S. Pat. App. No. 61/096,513, filed Sep. 12, 2008, which is incorporated herein by reference.

### FIELD OF THE INVENTION

The Invention is in fibers having small or micro- and nano-scale, diameters and to methods of forming such fibers. These fibers have substantially improved properties. The fibers can be used in filtration applications.

### BACKGROUND

Microfiber and nanofiber have been prepared from polyamides such as nylon materials in the past. Depending on their applications, such fibers have had some success.

Polyamides including nylons belong to a class of engineering polymers that have found a wide variety of successful thermoplastic commercial applications including in the synthetic fiber industry. In this class of materials, nylon-6 and nylon-6 6 have been most widely used because of their desirable combination of physical properties which include high strength, toughness, flexibility, thermal resistance, and chemical resistance. Polyamides are typically polymerized and processed in to useful forms. In certain types of processing where the solubility of the material is important, the poor solubility of these materials in common organic and environmentally friendly solvents limits their applications if they must be processed from solution. Strategies to dissolve these materials have included strong acids such as formic acid and sulfuric acid, fluorinated solvents such as 2,2,2-trifluoroethanol (TFE) and hexafluoroisopropanol (HFIP), and mixtures of TFE and methylene chloride. These solvents are hazardous and can add significant processing costs and in some cases can be detrimental to the material. For example, acidic solvents have been shown to degrade aliphatic polyamides and fluorinated solvents are considerably more expensive than commonly used organic solvents.

To overcome this limitation, the amido group in polyamides has been modified with various functional groups that improve the solubility of polyamides by disrupting polymer crystallinity. The reactions of nylon polymers with formaldehyde or mixtures of formaldehyde with alcohol yielded products with N-methylol and N-methoxymethyl functional groups, respectively. Some of these products are shown to be readily soluble in cosolvent mixtures of alcohol and water. The improved solubility of these products was attributed to the disruption of polymer chain packing and hydrogen bonding by substituting the amide hydrogens with modifying groups.

The use of certain nylon-6 6 to electrospin nanofibers in combination with other polymers and additive materials for filtration applications has been described in U.S. Pat. No. 6,743,273. However, the ability to produce nanofibers from this material was limited by its poor solution stability in EtOH/H₂O cosolvent mixtures and the formation of non-homogeneous nanofiber structures. Better nanofiber formation was only achieved after this material was blended with an alcohol soluble Nylon 6 Nylon 6 6 Nylon 6 10 polyamide copolymer. As will be discussed later in this invention, many of these solution blends still suffer from poor solution stability which limits their use in fiber forming processes.

Other approaches in improving the solubility of polyamides have involved N-alkylation and N-allylation in which amide hydrogens were deprotonated to form dimethyl sulfoxide (DMSO) soluble polyanions that were subsequently converted to N-alkylated and N-allylated products with heat or by reacting with allyl bromide.

A substantial need exists to show that improved materials can achieve, particularly in nanofiber sizes, increased environmental stability, increased processability including solubility in environmentally safe solvent systems, electrical conductivity for electrospinning and viscosity control. Lastly, when the fiber is used in a filter structure, the fiber must obtain effective filtration efficiency over an array of conditions including fluid type, type of particulate, particulate concentration, temperature and fluid velocity through the fiber mass.

### SUMMARY OF THE INVENTION

Each aspect of the invention comprises a micro- or nano-fiber comprising a novel nylon polymer. The fibers can be made into a layer or layers comprising a distribution of micro- or nano-fibers. The polymer in the fibers in any one layer can be crosslinked. A first aspect of the invention can comprise a fiber comprising a nylon copolymer comprising a bis-(amino substituted cycloalkyl)-alkane preferably a bis-(4-aminocyclohexyl)-alkane, such as the compound:

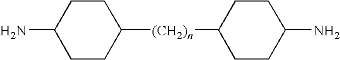

wherein n is 1 to 12 and at least one other nylon monomer. Such other monomers include, for example, a cyclic-lactam, an alpha,omega-alkylene diamine or an alpha,omega-alkylene dicarboxylic acid. Blends of this nylon with other modified and non-modified nylons are also useful.

In a second aspect of the invention, the invention comprises a fiber comprising a nylon comprising a nylon-alkylene oxide block copolymer comprising polymer blocks of an alkylene oxide monomer and polymer blocks of one or more nylon monomers. These polymers can be characterized as poly (alkylene oxide-b-amide) or PE-b-PA, having a polyether and polyamide block polymer. The alkylene oxide represents an ethylene oxide block, a propylene oxide block or other similar alkylene oxide block polymer segment. The amide block represents any nylon block segment. These materials can also be represented as (e.g.) an (PEO-b-PA) or as an (PPO-b-PA), wherein PEO and PPO represent block polymer segments of an ethylene oxide and propylene oxide and PA represents a polyamide or nylon block. These materials can be N-modified to obtain an N-modified-PE-b-PA by forming substituents on a fraction of the—N-segments in the polyamide. The alkylene oxide block can comprise a polymer comprising ethylene oxide, propylene oxide, tetramethylene oxide, or mixtures thereof. The nylon block can comprise polymer units derived from a cyclic-lactam, an alpha,omega alkylene diamine or an alpha,omega alkylene diacid or other similar nylon monomers.

### BRIEF DISCUSSIONS OF THE FIGURES

FIG. 1 is an ¹H-NMR spectrum of the polyethylene oxide-b-poly amide material.

FIG. 2a is an ¹H-NMR spectrum of the N-modified polyethylene oxide-b-poly amide material and 2b is an expanded portion of that spectrum.

FIGS. 3 and 4 show viscosity measurements of polymer solutions of the polymer materials disclosed.

FIG. 5 shows conductivity measurements of polymer solutions of the polymer materials disclosed.

FIG. 6 shows pH measurements of polymer solutions of the polymer materials disclosed.

FIGS. 7a through 9d show scanning electron micrographs of fibers made from the polymer materials disclosed.

FIG. 10 shows DSC scan of a material of the invention.

### DETAILED DESCRIPTION OF THE INVENTION

One aspect of this invention relates to the production of nanofibers from a bis(amino cycloalkyl) alkane, such as a bis(4-amino cyclohexyl)methane. PACM is a (e.g.) polymerized amino cyclohexyl methane. PACM N′ refers to a copolymer of a diacid with N′ carbon atoms and the bis(amino cycloalkyl) alkane amine monomer. Such polymers can also be copolymers comprising other nylon monomers. One impotant polymer comprises a nylon-6,66,PACM 6. Such nylon materials can be used in blends of this nylon and other modified and unmodified nylons. A preferred material is a modified nylon 6 such as N-methoxymethyl-nylon-6 blended with a polyamide copolymer consisting of nylon-6, nylon 66 and PACM 6. PACM 6 is informally p-aminocyclohexylmethane adipate, wherein the number 5 refers to the number of carbons in the adipate residue. Another important nylon polyamide copolymer comprises bis-(4-amino-cyclohexyl)-methane, adipic acid, hexane diamine and ε-caproloactone.

Another aspect of this invention describes the preparation of and uses of nanofibers from polyether-block-polyamide (PE-b-PA) copolymers, wherein the connector -b- connotes a block copolymer Polyether connotes a poly alkylene oxide. These materials belong to a class of thermoplastic elastomers consisting of rigid polyamide (PA) domains dispersed within a matrix of soft polyether (PE) segments. A wide range of physical properties can be achieved from these materials by altering the molecular weights and proportions of PA and PE segments. Because of the highly crystalline PA segment, PE-b-PA copolymers are not easily processed under mild solution conditions. In this invention, we describe the use of an PEO-b-PA, an N-alkoxy, N-alkyol or an N-alkoxyalkyl or an N-methoxymethy PEO-b-PA and the synthesis of a N-methoxymethyl-poly(ethyleneoxide-b-amide) (N-PEO-b-PA) copolymer that is soluble in common organic solvents including cosolvent mixtures of EtOH/H₂O. In addition, we show the preparation of thermoplastic elastomer nanofibers from solutions of N-PEO-b-PA that were crosslinked via the N-methoxymethyl group. Crosslinked nanofibers showed improved solvent resistance which makes these structures relevant for filtration applications in which resistance to heat, high humidity, solvent and mechanical damage from reverse pulse cleaning is desired.

We demonstrate that the solutions of these improved nylon materials have significantly improved solution stability in EtOH/H₂O cosolvent mixtures and that homogenous nanofiber structures were produced from homopolymer solutions of N-methoxymethyl-nylon-6 and solution blends with nylon-6,66,PACM 6. The molecular weights of the polymers are: M̅ₙ̅=1 to 6×10⁴ g/mol, M̅_̅{̅w̅}̅=2 to 10×10⁵ g/mol.

Because of their small diameter and high surface area, polymer nanofibers are highly susceptible to mechanical damage and degradation under high temperature, high humidity, and chemical exposure. Under these conditions, crosslinking the polymer matrix helps to stabilize the fiber and to retain the filtration characteristics of the nanofiber structures. We have found that nanofibers from N-methoxymethyl-nylon-6 and blends with nylon-6,66,PACM6 can be thermally crosslinked.

The materials of the invention are derived from the generic polymer class consisting of the polyamides and copolyamides including linear homopolyamides and copolyamides which are prepared in a known manner from cyclic lactams or bifunctional carboxylic acids and diamines or from omega-amino acids, lactams or suitable derivatives of these compounds. Useful monomers are those used in polymerization of such polyamides and copolyamides as nylon 3, 4, 5, 6, 8, 11, 12, 13, 6 6, 6 10 or 6 13; or a polyamide obtained from monomers including metaxylylenediamine and adipic acid or from trimethylhexamethylenediamine or isophoronediamine and adipic acid; nylon 6, 6 6, 6 10 or nylon 6, 6 6, 6 12; or a polyamide of ε-caprolactam/adipic acid/hexamethylenediamine/bis(4-aminocyclohexyl)methane, which are produced by copolymerizing equal amounts of adipic acid, caprolactam and hexamethylene diamine comonomers with bis(4-aminocyclohexyl)methane. The materials of this invention also include N-modified derivatives of all these homopolyamides and copolyamides which include N-alkyl, an N-vinyl containing chain, such as ethylene, allyl, etc., an N-methylol group, or an N-alkoxymethyl group.

The invention provides a range of improved polymeric materials. These polymers have improved physical and chemical stability. The polymer fine fiber (microfiber and nanofiber) can be fashioned into useful product formats. Nanofiber is a fiber with diameter less than 200 nanometer or 0.2 micron. Microfiber is a fiber with diameter larger than 0.2 micron, but not larger than 5 microns. This fine fiber can be made and then made into the form of an improved layered or multi-layer microfiltration media structure. The fine fiber layers of the invention comprise a random distribution of fine fibers which can be bonded to form an interlocking net. Such layers or nets can be formed on a filter substrate layer. Such layers are cellulosic, synthetic or mixed cellulosic/synthetic. Filtration performance is obtained largely as a result of the cooperation between the fine fiber barrier to the passage of particulate and contribution of the of filter substrate barrier. Structural properties of stiffness, strength, pleatability are provided by the substrate to which the fine fiber adhered. The fine fiber interlocking fiber networks provide important characteristics to a fiber layer. Fine fiber layers consist of relatively small spaces between the fibers and form pores in the layer at pore sizes that are useful in filter applications. Such spaces typically range, between fibers, of about 0.01 to about 25 microns or often about 0.1 to about 10 microns. The filter products comprising a fine fiber layer are combined with a choice of appropriate substrate. The fine fiber adds less than few microns and often less than a micron in thickness to the overall fine fiber layer on the substrate filter media. In service, the filters can stop incident particulate from passing through the fine fiber layer and can attain substantial surface loadings of trapped particles. The particles comprising dust or other incident particulates can form a dust cake on the fine fiber surface and maintain high initial and overall efficiency of particulate removal. Even with relatively fine contaminants having a particle size of about 0.01 to about 1 micron, the filter media comprising the fine fiber has a very high dust capacity.

The polymer materials as disclosed herein have substantially improved resistance to the undesirable effects of heat, humidity, high flow rates, reverse pulse cleaning, operational abrasion, submicron particulate penetration, cleaning of filters in use and other demanding conditions. The improved microfiber and nanofiber performance is a result of the improved character of the polymeric materials forming the microfiber or nanofiber. Further, the filter media of the invention using the improved polymeric materials of the invention provides a number of advantageous features including higher efficiency, lower flow restriction, high durability (stress related or environmentally related) in the presence of abrasive particulates and a smooth outer surface free of loose fibers or fibrils. The overall structure of the filter materials provides an overall thinner media allowing improved media area per unit volume, reduced velocity through the media, improved media efficiency and reduced flow restrictions.

A particularly preferred material of the invention comprises a small diameter fiber material having a dimension of about 5 to 0.005 microns, about 2 to 0.01 micron or between 0.8 to 0.05 micron. Such fibers with the preferred size provide excellent filter activity, ease of back or reverse pulse cleaning and other aspects.

The highly preferred polymer systems of the invention have adhering characteristic such that when fibers are contacted with a cellulosic or other synthetic or mixed cellulosic/synthetic substrate, they adhere to the substrate with sufficient strength such that they are securely bonded to the substrate and can resist the delaminating effects of a reverse pulse cleaning technique and other mechanical stresses. In such a mode, the polymer material must stay attached to the substrate while undergoing a pulse clean input that is substantially equal to the typical filtration conditions in a reverse direction across the filter structure. Such adhesion can arise from solvent effects of fiber formation as the fiber is contacted with the substrate or the post treatment of the fiber on the substrate with heat or pressure. However, polymer characteristics appear to play an important role in determining adhesion, such as specific chemical interactions like hydrogen bonding, contact between polymer and substrate occurring above or below T_{g}, and the polymer formulation such as conductivity stability and viscosity. Polymers plasticized with solvent or steam at the time of adhesion can have increased adhesion.

We have found that additive materials can improve the properties of certain of the copolymer materials in the form of a fine fiber. The resistance to the effects of heat, humidity, impact, mechanical stress and other negative environmental effect can be substantially improved by the presence of additive materials. We have found that while processing the microfiber materials of the invention, that the additive materials can improve the oleophobic character, the hydrophobic character and can appear to aid in improving the chemical stability of the materials. We believe that the fine fibers of the invention in the form of a microfiber are improved by the presence of these oleophobic and hydrophobic additives as these additives form a protective layer coating, ablative surface or penetrate the surface to some depth to improve the nature of the polymeric material. We believe the important characteristics of these materials are the presence of a strongly hydrophobic group that can preferably also have oleophobic character. Strongly hydrophobic groups include fluorocarbon groups, hydrophobic hydrocarbon surfactants or blocks and substantially hydrocarbon oligomeric compositions. These materials are manufactured in compositions that have a portion of the molecule that tends to be compatible with the polymer material affording typically a physical bond or association with the polymer while the strongly hydrophobic or oleophobic group, as a result of the association of the additive with the polymer, forms a protective surface layer that resides on the surface or becomes alloyed with or mixed with the polymer surface layers. Additive layers can range form 10 to 200 angstroms.

An important aspect of the invention is the utility of such microfiber or nanofiber materials formed into a filter structure. In such a structure, the fine fiber materials of the invention can consist of stand alone fiber layers or the polymer fiber material can be formed onto and adhered to a filter substrate. Natural fiber and synthetic fiber substrates, like spun bonded fabrics, non-woven fabrics of synthetic fiber and non-wovens made from the blends of cellulosics, synthetic and glass fibers, non-woven and woven glass fabrics, plastic screen like materials both extruded and hole punched, UF and MF membranes of organic polymers can be used. Sheet-like substrate or cellulosic non-woven web can then be formed into a filter structure that is placed in a fluid stream including an air stream or liquid stream for the purpose of removing suspended or entrained particulate from that stream. The shape and structure of the filter material is up to the design engineer. One important parameter of the filter elements after formation is its resistance to the effects of heat, humidity or both. One aspect of the filter media of the invention is a test of the ability of the filter media to survive immersion in warm water for a significant period of time. The immersion test can provide valuable information regarding the ability of the fine fiber to survive hot humid conditions and to survive the cleaning of the filter element in aqueous solutions that can contain substantial proportions of strong cleaning surfactants and strong alkalinity materials. Preferably, the fine fiber materials of the invention can survive immersion in hot water while retaining at least 50% of the fine fiber formed on the surface of the substrate. Retention of at least 50% of the fine fiber can maintain substantial fiber efficiency without loss of filtration capacity or increased back pressure, most preferably retaining at least 75% of the fiber for filtration purposes.

All of these materials and admixtures of materials can be crosslinked using appropriate crosslinking agents, processes or mechanisms. Nylons can be crosslinked using crosslinking agents that are reactive with the nitrogen atom in the amide linkage. Such reactive materials include monoaldehydes, such as formaldehyde, ureas, melamine-formaldehyde resin and its analogues, boric acids and other inorganic compounds. dialdehydes, diacids, urethanes, epoxies and other known crosslinking agents. Crosslinking can be accomplished using radiation source to bond adjacent polymer chains. Simple heating processes can act to crosslink. A preferred crosslinking agent for polyamide materials is p-toluene sulfonic acid (p-TSA). Crosslinking technology is a well known and understood phenomenon in which a crosslinking reagent reacts and forms covalent bonds between polymer chains to substantially improve molecular weight, chemical resistance, overall strength and resistance to mechanical degradation.

A fine fiber filter structure includes a bi-layer or multi-layer structure wherein the filter contains one or more fine fiber layers. Such layers can be used as is or can be combined with or separated by one or more synthetic, cellulosic or blended substrate webs. Another preferred motif is a structure including fine fiber in a matrix or blend of other fibers.

Electrospinning can be achieved in apparatus that includes a reservoir of fine fiber forming polymer solution in contact with an emitter. An emitter can be immersed into a reservoir of polymer. A droplet of the solution from the emitter is accelerated by an applied electrostatic field toward the collecting media. Facing the emitter, but spaced apart therefrom, is a substantially planar grid upon which the collecting media, substrate or combined substrate is positioned. The collecting media is passed over the grid at a rate to form the fiber in a continuous layer. Air can be drawn through the grid. A high voltage electrostatic potential is maintained between emitter and grid. In use, the electrostatic potential between grid and emitter imparts a charge to the polymer solution which causes liquid droplets to be emitted therefrom as thin fibers. Solvent is evaporated off the fibers during their flight. The fine fibers are directed to and bond to the substrate fibers as they form. Electrostatic field strength is selected to ensure that the acceleration of the polymer material is sufficient to render the material into a very thin microfiber or nanofiber structure as it is accelerated from the emitter to the collecting media. Increasing or slowing the advance rate of the collecting media can deposit more or less emitted fibers on the forming media, thereby allowing control of the thickness of each layer deposited thereon. Fibers smaller than 1 micron are best made from polymer solution. As the polymer mass is drawn down to smaller diameter, solvent evaporates and contributes to the reduction of fiber size. Electrostatic spinning can be done at a polymer solution flow rate of 0.001 to 5 ml/min per emitter, a target distance of 1 to 20 cm, and an emitter voltage of 1 to 60 kV.

The fine fiber materials of the invention can be used in a variety of filter applications including pulse clean and non-pulse cleaned filters for dust collection, gas turbines and engine air intake or induction systems; gas turbine intake or induction systems, heavy duty engine intake or induction systems, light vehicle engine intake or induction systems; “Z” filter; vehicle cabin air; off road vehicle cabin air, disk drive air, photocopier-toner removal; HVAC filters in both commercial or residential filtration applications.

Various filter designs are shown in patents disclosing and claiming various aspects of filter structure and structures used with the filter materials. Engel et al., U.S. Pat. No. 4,720,292, disclose a radial seal design for a filter assembly having a generally cylindrical filter element design, the filter element being sealed by a relatively soft, rubber-like end cap having a cylindrical, radially inwardly facing surface. Kahlbaugh et al., U.S. Pat. No. 5,082,476, disclose a filter design using a depth media comprising a foam substrate with pleated components combined with the microfiber materials of the invention. Stifelman et al., U.S. Pat. No. 5,104,537, relate to a filter structure useful for filtering liquid media. Liquid is entrained into the filter housing, passes through the exterior of the filter into an interior annular core and then returns to active use in the structure. Such filters are highly useful for filtering hydraulic fluids. Engel et al., U.S. Pat. No. 5,613,992, show a typical diesel engine air intake filter structure. The structure obtains air from the external aspect of the housing that may or may not contain entrained moisture. The air passes through the filter while the moisture can pass to the bottom of the housing and can drain from the housing. Gillingham et al., U.S. Pat. No. 5,820,646, disclose a Z filter structure that uses a specific pleated filter design involving plugged passages that require a fluid stream to pass through at least one layer of filter media in a “Z” shaped path to obtain proper filtering performance. The filter media formed into the pleated Z shaped format can contain the fine fiber media of the invention. Glen et al., U.S. Pat. No. 5,853,442, disclose a bag house structure having filter elements that can contain the fine fiber structures of the invention. Berkhoel et al., U.S. Pat. No. 5,954,849, show a dust collector structure useful in processing typically air having large dust loads to filter dust from an air stream after processing a workpiece generates a significant dust load in an environmental air. Lastly, Gillingham, U.S. Design Pat. No. 425,189, discloses a panel filter using the Z filter design. A general understanding of some of the basic principles and problems of air filter design can be understood by consideration of the following of filter media types including surface loading media and, depth media. Each of these types of media has been well studied, and each has been widely utilized. Certain principles relating to them are described, for example, in U.S. Pat. Nos. 5,082,476; 5,238,474; and 5,364,456. The complete disclosures of these three patents are incorporated herein by reference.

### EXPERIMENTAL AND DETAILED DISCUSSION OF THE FIGURES

### Example 1

### Synthesis of N-methoxymethyl-poly(ethyleneoxide-b-amide) (N-PEO-b-PA)

Formic acid (≧96%, 104.19 g, 2.26 mol) was added to a glass kettle sealed with a 3-neck glass lid. The kettle was then equipped with a condenser, temperature probe, mechanical stirrer, and a heating mantle. The solution was heated to 60° C. and PEO-b-PA (12.73 g) was added and stirred until the polymer was fully dissolved. Paraformaldehyde (95%, 3.42 g, 1.14×10⁻¹ mol) was added to 4.4 mL methanol in an Erlenmeyer flask. Potassium hydroxide (50 mg) was added to the paraformaldehyde-methanol mixture and the solution was heated to 60° C. with stirring. The paraformaldehyde solution (3.3 mL) was added dropwise via syringe into the PEO-b-PA formic acid solution over 1.25 hours. The reaction mixture was cooled and the polymer was precipitated in 500 mL THF. The precipitated polymer was neutralized with NH₄OH and washed repeatedly with 500 mL aliquots of DI H₂O. The polymer was dried in a vacuum oven at room temperature for 72 hours.

### Example 2

### Solution Preparation of N-PEO-b-PA

N-PEO-b-PA (1.226 g), prepared in Example 1, was added to a glass vial filled with an ethanol/water cosolvent mixture (10.7 mL, 82/18 wt % EtOH/H₂O) and the polymer was stirred until dissolved. An aliquot of this solution (3.46 g) was added to a glass vial and p-TSA was added and stirred to a final concentration of 1.37×10⁻² M.

### Example 3

### Solution Preparation of Nylon-6,66,PACM6

Two hundred grams of nylon-6,66,PACM6 (p-aminocyclohexyl-methane adipate), a polyamide copolymer comprising bis-(4-amino-cyclohexyl)-methane, adipic acid, hexane diamine, and ε-caproloactone, was placed into a 4000 mL glass kettle filled with a cosolvent mixture of ethanol and water (2185 mL, 80/20 wt % EtOH/H₂O). The glass kettle was sealed with a 3-neck glass lid and equipped with a mechanical stirrer, a temperature probe, and a condenser. The glass kettle was placed in a heating mantle and solutions were stirred for 3 hours at 60° C. until the polymer was fully dissolved. The solution was then cooled to room temperature and stirred for an additional 3 hours to a yield 10 wt % homogeneous solution.

### Example 4

### Solution Preparation of FR-101 and Blends with Nylon-6,66,PACM6

Solution blends were prepared by mixing the two polymer solutions of Examples 3 and a methoxy methylated Nylon 6 (m.w. 20,000) FR-101, (Namariichi Co., Ltd., Japan) (see copending U.S. Ser. No. 12/558,496) at compositions of 50/50 wt % (Example 4), and 70/30 wt % FR-101 to nylon-6,66,PACM6 (Example 5). Para-TSA was also added to 300 g aliquots of the polymer blend solutions and stirred for 1 h at room temperature. Final p-TSA concentrations were 7.55×10⁻³M for 50/50 wt % FR-101/nylon-6,66,PACM6 mixtures, and 1.05×10⁻²M for 70/30 wt % FR-101/nylon-6,66,PACM6 mixtures. The materials of Examples 4 and 5 were subsequently used as stock to prepare solutions of 3.39×10⁻³M p-TSA for FR-101, 1.70×10⁻³M p-TSA for 50/50 wt % FR-101/FR-101, nylon-6,66,PACM6, and 2.38×10⁻³M p-TSA for 70/30 wt % FR-101/nylon-6,66,PACM6.

### Example 5

### Solution Preparation of Nylon 6

A solution of Nylon 6 was prepared using the procedure described in Example 3. Para-TSA was added to 300 g aliquots of the solution and stirred for 1 hour at room temperature to give a solution with a final p-TSA concentration of 1.39×10⁻²M.

The materials described were characterized by GPC, NMR, DSC, and SEM. Solution characteristics were measured and samples were electrospun into fibers as described below. The fine fiber filter structures were tested for basic filter efficiency properties.

### Gel Permeation Chromatography

### GPC

Molecular weight of exemplary materials was determined by GPC analysis performed on a Waters GPC instrument equipped with a Waters 600 pump, Waters 717 plus Autosampler, a Polymer Laboratories PL HFIP gel guard column (50×7.5 mm), and a Waters 2410 refractive index detector. Two Polymer Laboratories PL HFIP gel GPC columns (250×4.66 mm) connected in series were operated with TFE solvent. A constant flow rate of 1 mL/min was used for the TFE solvent. Polymethylmethacrylate standards (Polymer Laboratories) were used for molecular-weight calibration. GPC data analysis and processing was performed with Empower 2 software. Polymer samples were dissolved in TFE at concentrations of ˜1.4×10⁻³ g/mL prior to analysis. GPC results for Nylon-6,66 PACM6 were: M̅ₙ̅=2.99×10⁴ g/mol, M̅_̅{̅w̅}̅=5.31×10⁴ g/mol, and PDI=1.78.

### Electrospinning

Nanofibers were electrospun from solutions described in the Examples by applying a voltage of 10.7 to 16.6 kV to polymer solutions eluted from syringe needles at a flow rate of 0.10 mL/min. The distance from the emitter to collector substrate was fixed at 3 inches. Nanofibers were electrospun onto a cellulose substrate (product no. FF6168; Hollingworth and Vose Company) and thermally crosslinked by annealing in a 150° C. oven for 10 min.

### Proton (¹H)-NMR Analysis

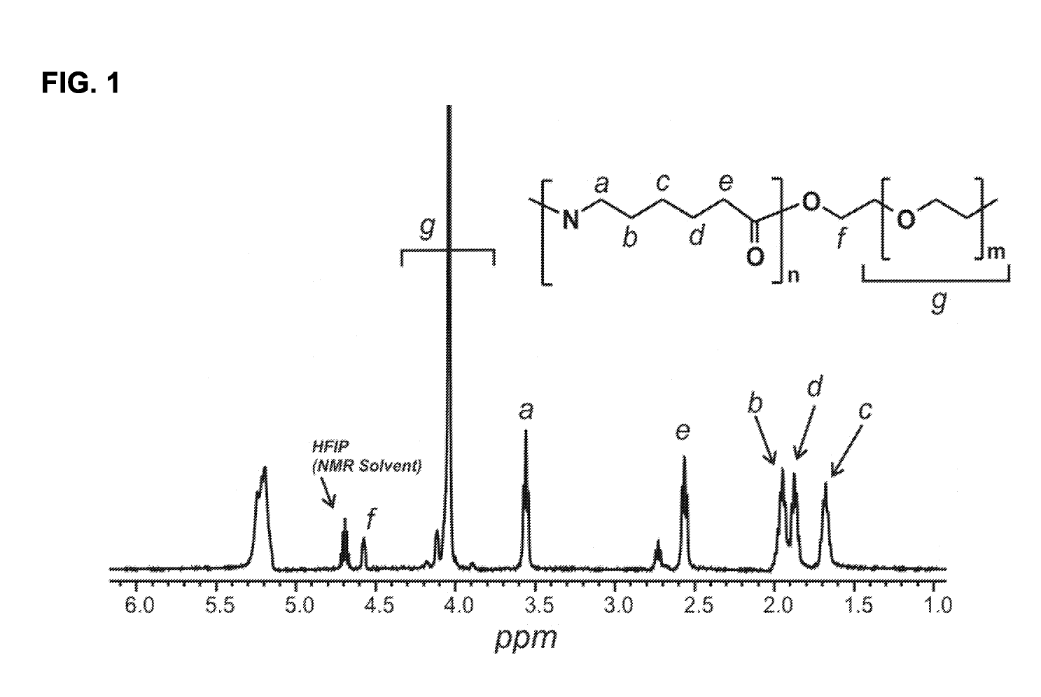

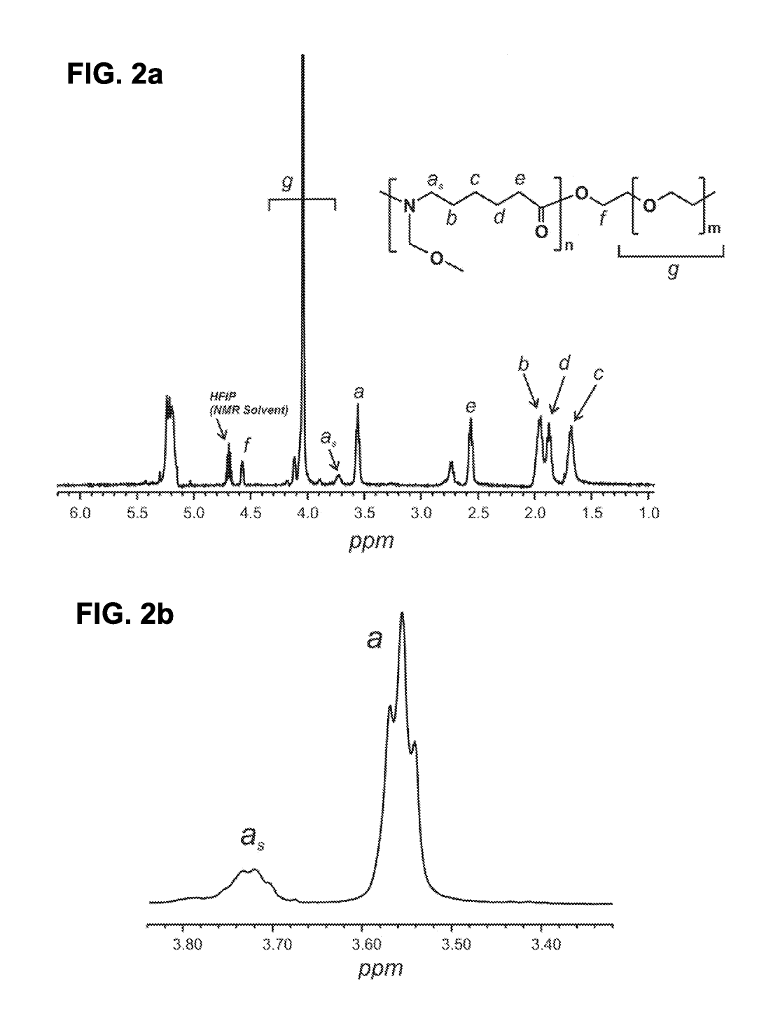

Samples for ¹H-NMR analysis were prepared by dissolving PEO-b-PA and N-PEO-b-PA materials described in the examples in HFIP-d₂ at a concentration of ˜17 mg/mL. NMR measurements were made on polymer-HFIP-d₂ solutions sealed in Wilmad® NMR tubes (Aldrich). Proton (¹H)—NMR spectra were obtained on Varian Inova 500 MHz spectrometer. NMR data processing and analysis was performed with MestRec software (Mestrelab Research). See FIGS. 1, 2a and 2b.

### Differential Scanning Calorimetry

### DSC

Polymer thermal transitions were obtained with a DSC 2920 instrument (TA Instruments). Scans were obtained at a rate of 10° C./min over a temperature range of 0-300° C. The sample chamber was purged with N₂ during analysis. Data acquisition and analysis was performed with TA Universal Analysis software (TA Instruments). Melting peak transitions were;

Tₘ=185° C. for nylon-6,66,PACM6,

### Tₘ=199° C. for N-PEO-b-PA, and

### Tₘ=205° C. for PEO-b-PA.

### See FIG. 10.

### Proton NMR Spectra of PEO-b-PA

FIG. 1 shows the ¹H-NMR spectra of the unmodified PEO-b-PA material described in Example 1. FIGS. 2a and 2b shows the ¹H-NMR spectrum of modified N-PEO-b-PA. Specifically, FIG. 2a is a full spectrum and FIG. 2b is an expanded view of the region from 3.4 ppm to 3.8 ppm. FIG. 2 shows characteristic peaks that correspond to nylon-6 and PEO segments. FIG. 2 shows an additional resonance peak at ˜3.7 ppm from downfield shifted protons alpha to the nitrogen in the substituted carbonamide groups. Using equation 1, the degree of substitution in N-PEO-b-PA was calculated to be ±9%.

FIG. 10 shows a DSC of PEO-b-PA and N-PEO-b-PA of example 1. This DSC analysis shows that N-substitution caused a slight decrease in the melting temperature of N-PEO-b-PA (Tₘ=199° C.) relative to the PEO-b-PA starting material (Tₘ=205° C.). The crystallinity of polyamide segments in N-PEO-b-PA was calculated to be ˜85% by comparing the material's heat of fusion to a value obtained from a reference nylon-6 homopolymer. We found that even this relatively low degree of modification had a significant influence on the solubility of the PEO-b-PA copolymer. By contrast to PEO-b-PA, which is insoluble in most common organic solvents, N-PEO-b-PA was readily soluble in various solvents which included alcohols, chlorinated solvents, DMF, and mixtures of EtOH/H₂O.

### Viscosity, PH, and Conductivity Measurements

Time-based viscosity measurements of 10 wt % polymer solutions in EtOH/H₂O cosolvent mixtures were made to investigate polymer solution stability.

Polymer solution viscosity measurements were made at 25° C. with a Brookfield viscometer equipped with a Fischer Scientific water temperature bath.

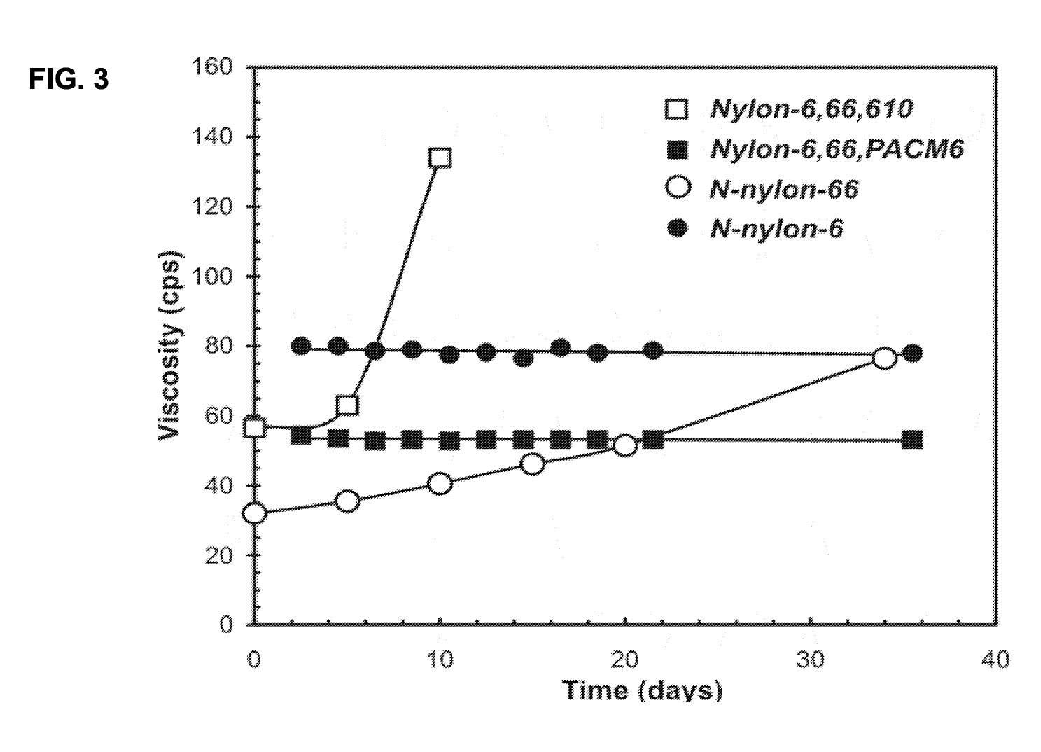

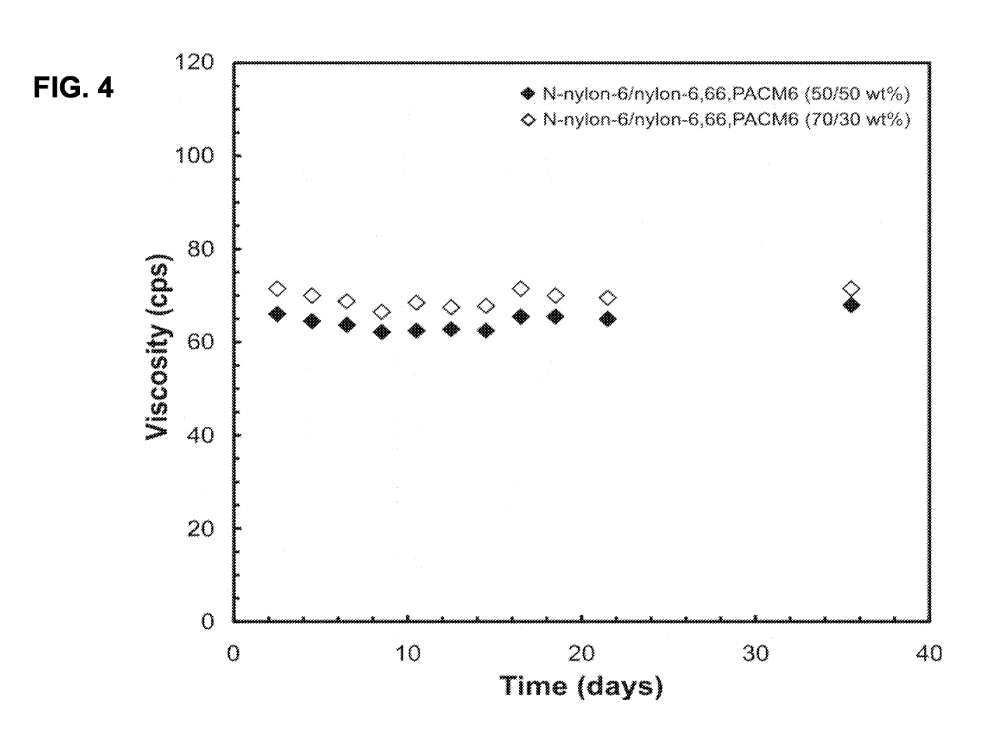

FIG. 3 shows a viscosity versus time plot for 10 wt % homopolymer solutions of polymers similar to those of the Examples. FIG. 4 shows a viscosity versus time plot for 10 wt % polymer blend solutions in 80/20 wt % EtOH/H₂O. We found that N-PA-6 and nylon-6,66,PACM6 were very stable with solution viscosity values remaining virtually constant over a 35 day measurement period. For comparison, we also measured the solution viscosity of N-methoxymethyl-nylon-66 (N-PA-66) and nylon-6,66,610 (PA-6,66,610) solutions. By contrast, we found that the stability of these solutions was significantly reduced with N-PA-66 solutions showing a 139% viscosity increase over 34 days, and PA-6,66,610 solutions showing a 137% viscosity increase over a 10 day period. Similarly, solution blends of N-PA-6 and nylon-6,66,PACM6 (FIG. 4) were more stable than blends of N-PA-66 and PA-6,66,610.

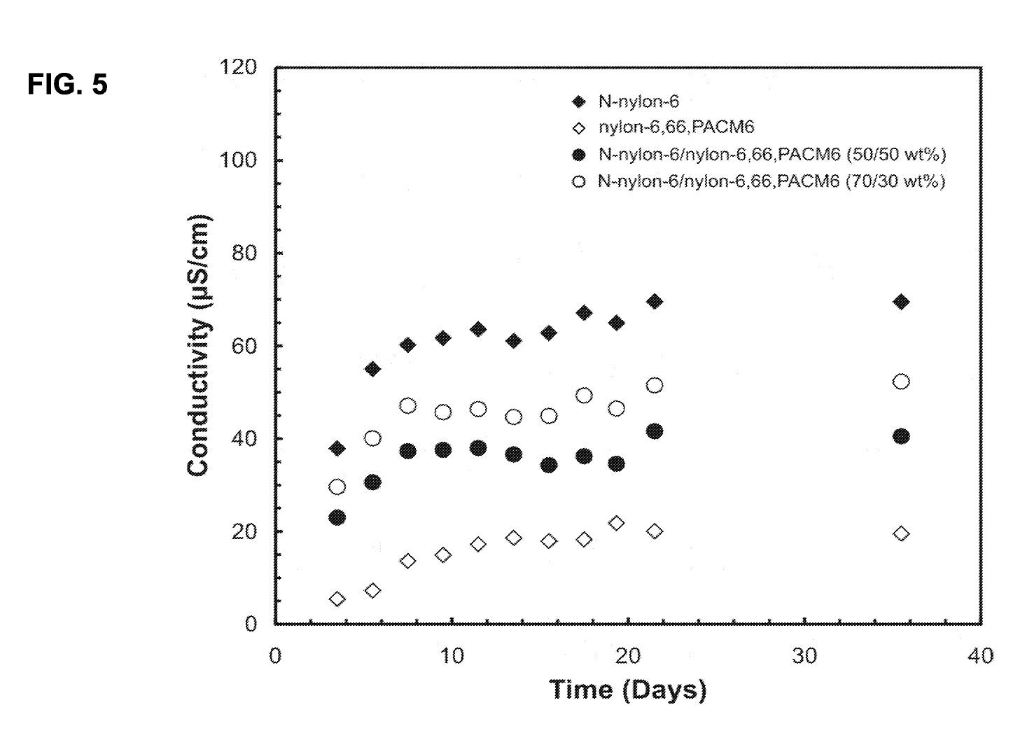

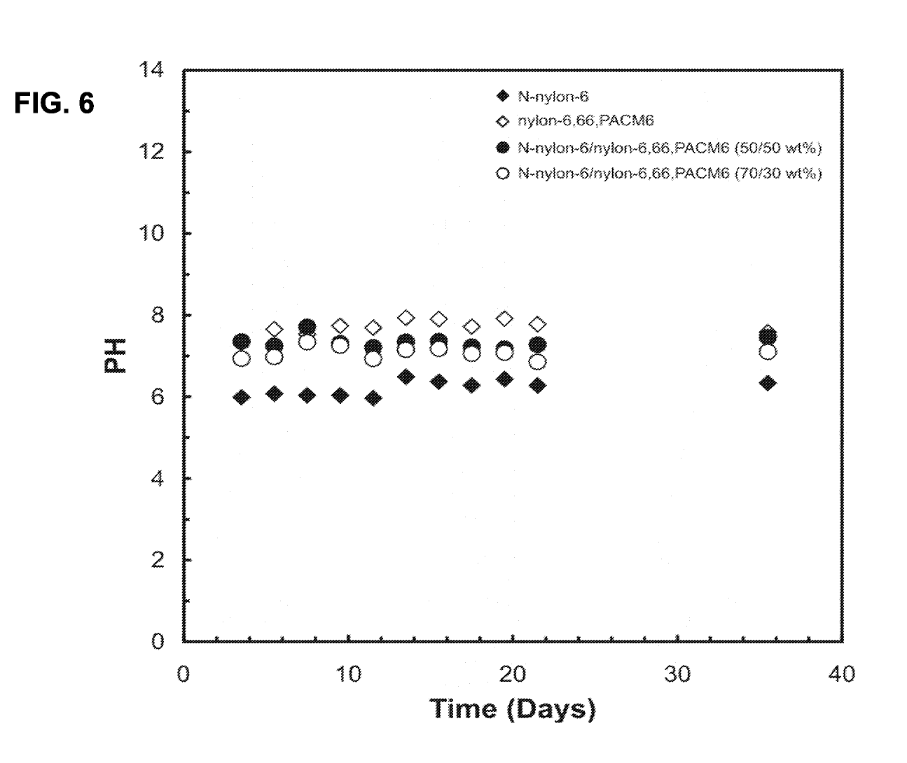

Conductivity and pH measurements of polymer solutions similar to those of the examples were made with a Mettler Toledo instrument. Measurement of solution conductivity and pH, FIGS. 5 and 6, showed that these values did not change substantially during the 34 day period. FIG. 5 shows conductivity versus time plot for 10 wt % polymer solutions in 80/20 wt % EtOH/H₂O. FIG. 6 shows a pH versus time plot for 10 wt % polymer solutions in 80/20 wt % EtOH/H₂O. The high solution stability of these polymers in EtOH/H₂O might aid in improving solution shelf life in electrospinning applications. It is well documented that the resulting morphology of electrospun fine fibers are directly related to precursor solution properties. Slight changes in solution properties can cause very noticeable changes in the morphology of fine fibers and fine fiber mats. Therefore, solutions with prolonged stability are desirable in commercial electrospinning of fine fibers where it is crucial that solution properties do not change to a significant extent during the utilization period.

### Scanning Electron Microscopy

### SEM

Scanning electron microscopy was performed on samples that were first mounted onto aluminum stubs with carbon tape and then sputtered with gold. Images were obtained with a JEOL JSM-5900LV scanning electron microscope.

Electrospinning and LEFS Measurements

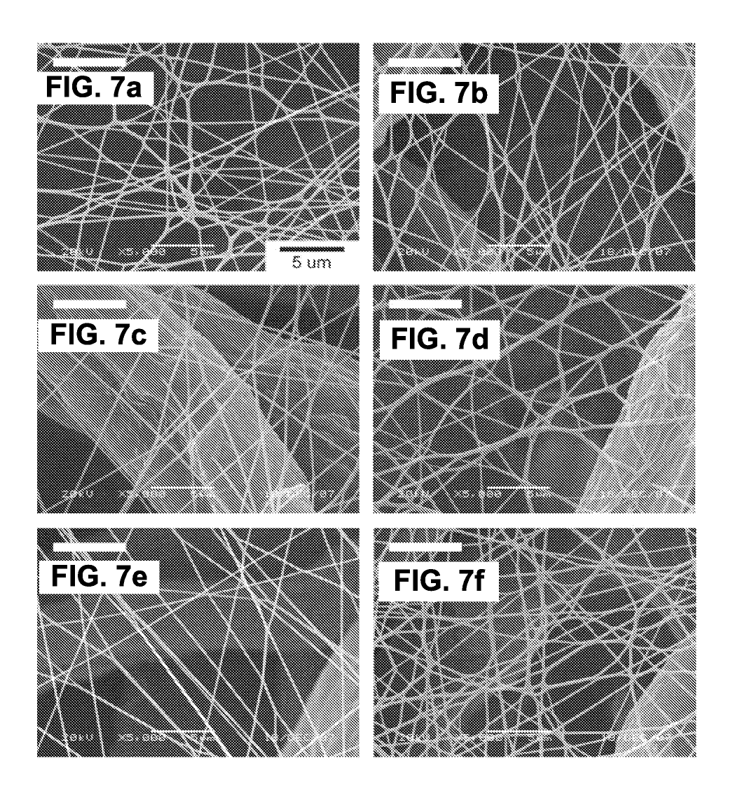

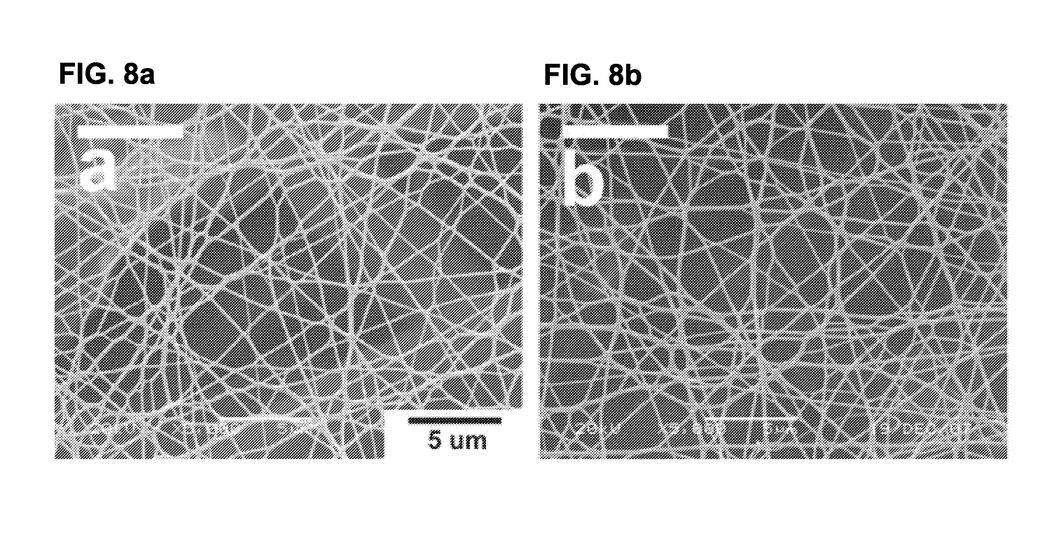

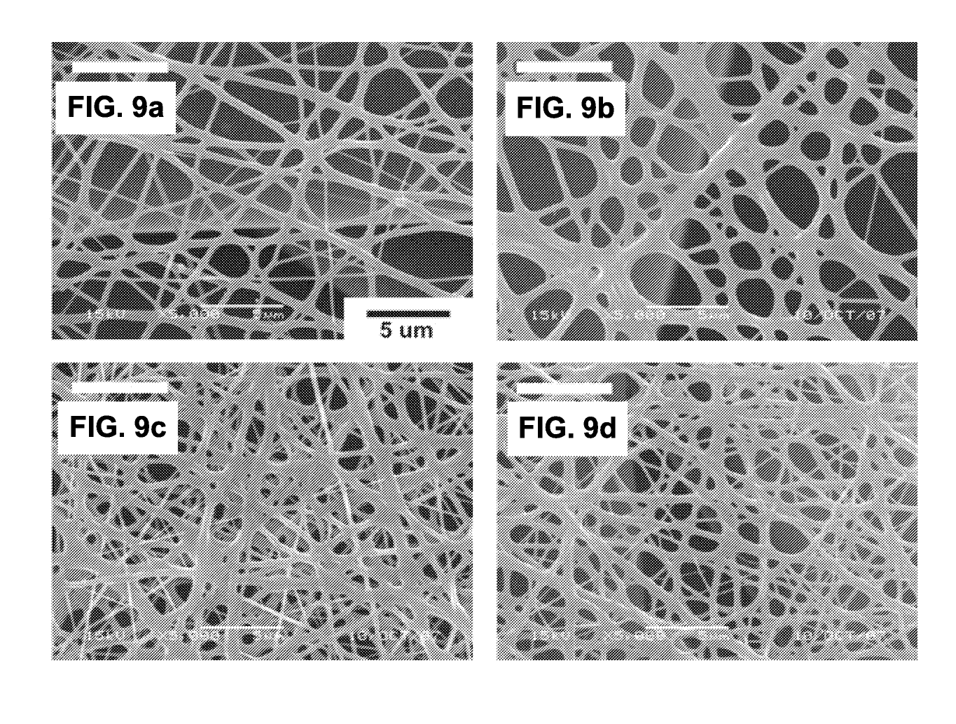

Nanofibers were prepared by electrospinning solutions of N-PA-6 and blends with nylon-6,66,PACM6 in EtOH/H₂O. FIG. 7 shows SEM images of nanofibers prepared from 10 wt % solutions of (FIG. 7 a,b) N-PA-6 with 7.09×10⁻³M p-TSA and blends of (FIG. 7 c,d) 50/50 wt % N-PA-6/nylon-6,66,PACM6 with 4.15×10⁻³M p-TSA and (FIG. 7 e,f) 70/30 wt % N-PA-6/nylon-6,66,PACM6 with 5.36×10⁻³M p-TSA. Nanofibers (FIG. 7 a,c,e) were annealed at 150° C. for 10 min and (FIG. 7 b,d,f) annealed at 150° C. for 10 min and immersed in EtOH for 10 min. We found that these solutions produced nanofibers with homogenous morphology regardless of the composition of N-PA-6 and nylon-6,66,PACM6. For example, SEM results show that solutions of N-PA-6 produced well-defined nanofibers without blending with nylon-6,66,PACM6 (FIG. 7 a,b). We also found that nanofibers were undamaged from EtOH immersion after crosslinking at 150° C. for 10 min (FIG. 7 b,d,f). Surprisingly, nanofibers from N-PA-6 also crosslinked at annealing temperature without addition of p-TSA catalyst. FIG. 8 shows SEM images of nanofibers prepared from 10 wt % polymer solutions of N-PA-6 with 0 M p-TSA. Nanofibers were annealed at 150° C. for 10 min (FIG. 8a) and annealed at 150° C. for 10 min and soaked in EtOH for 10 min (FIG. 8b). FIG. 9 shows SEM images of nanofibers prepared from solutions of N-PEO-b-PA in 82/18 wt % EtOH/H₂O. Images were obtained after nanofibers were (FIG. 9 a,c) annealed at 150° C. for 10 min and (FIG. 9 b,d) annealed at 150° C. for 10 min and immersed in EtOH for 10 min. p-TSA concentrations were (FIG. 9 a,b) 0 M and (FIG. 9 c,d) 1.37×10⁻²M. Nanofibers prepared from solutions of N-PEO-b-PA also crosslinked from thermal annealing without adding p-TSA catalyst (FIG. 9 a,b). However, for this material, the extent of nanofiber crosslinking and resistance to EtOH solvent was improved with p-TSA addition (FIG. 9 c,d).

The LEFS measurement were done according to ASTM1215-89. Particle capture efficiency was measured on a LEFS bench using 0.80 μm latex spheres with velocity of 20 ft/min as a test challenge contaminant. Measurements were made on substrate and nanofiber composite samples that were annealed at 150° C. for 10 min. Measurements were also made on substrate and nanofiber composite samples that were annealed at 150° C. for 10 min and soaked in EtOH for 10 min. Samples soaked in EtOH were air dried for at least 3 h prior to measurement. Filter efficiency (LEFS) measurements (Table 1) of nanofibers from N-PA-6 and blends with nylon-6,66,PACM6 showed high particle capture efficiency with values ranging from 73-80%. LEFS measurements of thermally crosslinked samples that were immersed in EtOH for 10 min showed an efficiency retention of 60-68%. The efficiency retained from nanofibers alone (Fᵣ) in EtOH immersed samples was calculated to be 68-82%, using equation 2:

$${F}_{r} = \frac{{F}_{x}}{{F}_{i}} \qquad Equation 2$$

where Fₓ is the post EtOH soak nanofiber efficiency, and Fᵢ is the initial nanofiber layer efficiency. Fᵢ and Fₓ are expressed by equations 3 and 4:

Fᵢ=1−e^{ln(1-E}^{ᵢ}^{)-ln(1-E}^{ᵢₛ}⁾ Equation 3

Fₓ=1−e^{ln(1-E}^{ₓ}^{)-ln(1-E}^{ₛₓ}⁾ Equation 4

where Eᵢ=initial composite efficiency, Eₓ=post EtOH soak composite efficiency, Eᵢₛ=initial substrate efficiency, and Eₓₛ=post EtOH soak efficiency. Using equation 5, the percent of nanofibers retained after EtOH immersion was calculated to range from 58-76%.

$$\% = \frac{log ( 1 - {F}_{x} )}{log ( 1 - {F}_{i} )} \qquad Equation 5$$

TABLE 1
Filter Efficiency Measurements of Nanofiber Filter Media.

| | | | | % | | |
|---|---|---|---|---|---|---|
| | | | % | Composite | % Nanofiber | |
| | | | Composite | Eff. | Eff. | % |
| Polymer | | | Eff. | (Annealed + | Retained | Nanofibers |
| Composition | Wt % N-PA-6 | p-TSA (M) | (Annealed) | EtOH) | (F₅) | Retained |
| REF | 100 | 0 | 73 | 63 | 77 | 69 |
| REF | 100 | 1.39 × 10⁻² | 74 | 60 | 68 | 58 |
| REF | 100 | 3.39 × 10⁻³ | 73 | 64 | 81 | 73 |
| N-PA-6/PA- | 50 | 7.55 × 10⁻³ | 77 | 67 | 78 | 68 |
| 6,66,PACMS6 | | | | | | |
| N-PA-6/PA- | 50 | 1.70 × 10⁻³ | 80 | 66 | 71 | 59 |
| 6,66,PACMS6 | | | | | | |
| N-PA-6/PA- | 70 | 1.05 × 10⁻³ | 77 | 68 | 82 | 74 |
| 6,66,PACMS6 | | | | | | |
| N-PA-6/PA- | 70 | 2.38 × 10⁻³ | 78 | 68 | 79 | 69 |
| 6,66,PACMS6 | | | | | | |

REF = FR-101Polymer solution

We claim:

1. A fiber comprising a polyamide polymer, the fiber comprising a diameter of about 0.001 to about 5 microns; wherein the polyamide comprises a block copolymer comprising nylon-b-alkylene oxide polymer blocks, the alkylene oxide blocks comprising one or more alkylene oxide monomers and the nylon polymer blocks comprising one or more nylon monomers.

2. The fiber of claim 1 wherein the alkylene oxide block can comprise ethylene oxide, propylene oxide, tetramethylene oxide, or mixtures thereof.

3. The fiber of claim 1 wherein the nylon block can comprise a residue derived from a cyclic lactam, an alpha omega alkylene diamine, an aromatic diamine or an alpha omega alkylene diacid, and an aromatic diacid.

4. The fiber of claim 1 where the polyamide block comprises N-modified blocks.

5. The fibers of claim 4 where, where the N-modified group comprises N-hydroxyalkyl, N-alkoxyalkyl, N-allyloxyalkyl, N-allyl, N-alkyl, or mixtures thereof.

6. The fiber of claim 1 wherein the diameter of the fiber is about 0.01 to about 2 microns.

7. The fiber of claim 1 where the fiber is crosslinked.

8. A fiber comprising a polyamide polymer, the fiber comprising a diameter of about 0.001 to about 5 microns; wherein the polyamide comprises a nylon copolymer comprising a bis-(amino substituted cycloalkyl)-alkane.

9. The fiber of claim 16 wherein the bis-(amino substituted cycloalkyl)-alkane comprises a bis-(4-aminocyclohexyl)-methane, such as the compound: 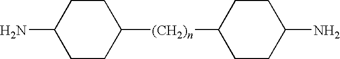
and at least one other nylon monomer.

10. The fiber of claim 16 wherein the bis-(amino substituted cycloalkyl)-alkane comprises the compound: 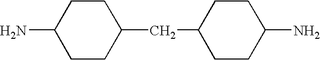
and at least one other nylon monomer.

11. The fiber of claim 16 wherein the nylon comprises a polyamide comprising adipic acid, ε-caprolactam, hexamethylene diamine and bis(4-aminocyclohexyl)methane.

12. The fiber of claim 16 where the fiber is crosslinked.

13. The fibers of claim 16 where, where the nylon comprises a N-modified group comprises N-hydroxyalkyl, N-alkoxyalkyl, N-allyloxyalkyl, N-allyl, N-alkyl, or mixtures thereof.

14. The fiber of claim 16 wherein the nylon comprises an alkylol or an alkoxyalkyl modified nylon.

15. A filter medium comprising a layer of fiber and a filter substrate, the fiber comprising a polyamide polymer of claim 1.

16. A filter medium comprising a layer of fiber and a filter substrate, the fiber comprising a polyamide polymer, the fiber comprising a polymer of claim 8

17. A method of filtering comprising passing a fluid stream having entrained particulate through a filter comprising the filter medium of claim 15 and removing the particulate.

18. A method of filtering comprising passing a fluid stream having entrained particulate through a filter comprising the filter medium of claim 16 and removing the particulate.
